(19) United States
(12) Patent Application Publication
(10) Pub. No.: US 2025/0188883 A1
(43) Pub. Date: Jun. 12, 2025

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventor: Tatsuyoshi OMURA, Tokyo (JP)

(73) Assignee: TOYOTA JIDOSHA KABUSHIKI KAISHA, Toyota-shi (JP)

(21) Appl. No.: 18/945,744

(22) Filed: Nov. 13, 2024

(30) Foreign Application Priority Data
Dec. 11, 2023 (JP) 2023-208565

(51) Int. Cl. F02D 35/00; B60H 1/00

(52) U.S. Cl. CPC F02D 35/00; B60H 1/0073; F02D 2200/06

(57) ABSTRACT

An information processing device controls a vehicle that executes a first mode in which an air conditioner is actuated by electric power of a battery and a second mode in which the air conditioner is actuated by electric power generated using dynamic power of an internal combustion engine. The information processing device includes a processor. The processor determines whether the remaining amount of the battery is equal to or higher than a first threshold, in response to receiving an actuation request for the air conditioner by a remote operation. The processor determines whether a predetermined condition as an execution condition for the second mode is satisfied, when determination is made that the remaining amount of the battery is less than the first threshold. The processor controls the vehicle such that the second mode is executed, when determination is made that the predetermined condition is satisfied.

### CROSS-REFERENCE TO RELATED APPLICATION

This application claims priority to Japanese Patent Application No. 2023-208565 filed on Dec. 11, 2023, incorporated herein by reference in its entirety.

### BACKGROUND

### 1. Technical Field

The present disclosure relates to an information processing device and an information processing method.

### 2. Description of Related Art

In an electric air conditioner that is equipped in a hybrid electric vehicle (HEV) or a plug-in hybrid electric vehicle (PHEV) and that is actuated by a timer or a remote operation, there is known a technology of actuating the air conditioner while charging a battery by actuating an internal combustion engine, when the remaining amount of the battery is equal to or lower than a predetermined level (for example, Japanese Unexamined Patent Application Publication No. 2012-188062 and Japanese Unexamined Patent Application Publication No. 2009-120022).

### SUMMARY

The present disclosure provides a technology that more suitably perform the control of the air conditioner depending on the remote operation.

An aspect of the present disclosure is an information processing device that controls a vehicle that executes a first mode and a second mode, the first mode being a mode in which an air conditioner is actuated by electric power of a battery, the second mode being a mode in which the air conditioner is actuated by electric power that is generated using dynamic power of an internal combustion engine.

The information processing device includes a processor.

The processor is configured to:
receive an actuation request for the air conditioner by a remote operation;
determine whether the remaining amount of the battery is equal to or higher than a first threshold, in response to receiving of the actuation request;
determine whether a predetermined condition that is an execution condition for the second mode is satisfied, in response to determination is made that the remaining amount of the battery is less than the first threshold; and
control the vehicle such that the second mode is executed, in response to determination is made that the predetermined condition is satisfied.

Another aspect of the present disclosure is an information processing method for controlling a vehicle that executes a first mode and a second mode, the first mode being a mode in which an air conditioner is actuated by electric power of a battery, the second mode being a mode in which the air conditioner is actuated by electric power that is generated using dynamic power of an internal combustion engine.

The information processing method includes:
receiving an actuation request for the air conditioner by a remote operation;
determining whether the remaining amount of the battery is equal to or higher than a first threshold, in response to receiving of the actuation request;
determining whether a predetermined condition that is an execution condition for the second mode is satisfied, in response to determination is made that the remaining amount of the battery is less than the first threshold; and
controlling the vehicle such that the second mode is executed, in response to determination is made that the predetermined condition is satisfied.

Further, another aspect of the present disclosure may be a program for causing a computer to execute the above information processing method, or a non-transitory storage medium in which the program is stored so as to be capable of being read by the computer.

The present disclosure can provide a technology that makes it possible to more suitably perform the control of the air conditioner depending on the remote operation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a system in an embodiment;

FIG. 2 is a diagram schematically showing respective exemplary hardware configurations of a vehicle, a user terminal and a server that are included in the system in the embodiment;

FIG. 3 is a diagram schematically showing exemplary vehicle information in the embodiment;

FIG. 4 is a diagram schematically showing an exemplary remote signal in the embodiment;

FIG. 5 is a diagram schematically showing exemplary vehicle data in the embodiment;

FIG. 6 is a block diagram schematically showing an exemplary software configuration of the server in the embodiment;

FIG. 7 is a diagram schematically showing an exemplary first actuation command and second actuation command in the embodiment;

FIG. 8 is a flowchart showing an exemplary processing routine that is executed by the server in the embodiment;

FIG. 9 is a diagram showing an exemplary selection screen in a modification;

FIG. 10 is a flowchart showing an exemplary processing routine that is executed by the server in the modification;

FIG. 11 is a diagram showing an exemplary second actuation command in the modification; and

FIG. 12 is a diagram showing another exemplary second actuation command in the modification.

### DETAILED DESCRIPTION OF EMBODIMENTS

In recent years, a remote air conditioning in which an air conditioner of a parked vehicle is actuated by user's remote-control operation through a terminal such as a smartphone has been popularized. As an example, the following technology is known. In an HEV or PHEV in which an electric air conditioner is equipped, when an actuation request for the air conditioner by a remote operation is generated, the technology actuates the air conditioner by the electric power of a battery without actuating an internal combustion engine, if the remaining amount of the battery is equal to or higher than a threshold, and actuates the air conditioner by the electric power of the battery while charging the battery by actuating the internal combustion engine, if the remaining amount of the battery is lower than the threshold.

There can be a case where the execution of the remote air conditioning with the actuation of the internal combustion engine is undesirable, depending on the state of the vehicle or the parking environment of the vehicle. For example, when the remote air conditioning with the actuation of the internal combustion engine is executed in the case where the remaining amount of the fuel of the internal combustion engine is small, the case where the vehicle is parked at a place unsuitable for the idling of the internal combustion engine, or other cases, there is a possibility that the travelable distance of the vehicle is excessively shortened or an influence (for example, noise, exhaust gas, or the like) is given to the environment around the vehicle. Consequently, there is room for improvement in the control of the air conditioner depending on the remote operation.

An information processing device according to the present disclosure controls a vehicle configured to be capable of executing a first mode in which the air conditioner is actuated by the electric power of the battery and a second mode in which the air conditioner is actuated by the electric power that is generated using the dynamic power of the internal combustion engine. The vehicle that is a control object of the information processing device according to the present disclosure is an HEV or PHEV in which an electric air conditioner is equipped, for example. In the information processing device according to the present disclosure, a control unit receives an actuation request for the air conditioner by the remote operation. As an example, the actuation request may be sent to the information processing device from a terminal that is used by a user of the vehicle, through a network.

The control unit determines whether an execution condition for the first mode is satisfied, in response to the reception of the actuation request. As an example, the execution condition for the first mode in the present disclosure may include a condition that the remaining level (state of charge (SOC)) of the battery is equal to or higher than a first threshold. The first threshold is a lower limit of a remaining battery level at which the execution of the remote air conditioning in the first mode is expected not to influence the traveling of the vehicle, and the like. As an example, the first threshold may be set to a larger value as the capacity of the battery is lower. In the case where it is determined that the execution condition for the first mode is satisfied, the control unit controls the vehicle such that the first mode is executed. In this case, it is possible to actuate the air conditioner using the electric power of the battery, without actuating the internal combustion engine.

Further, in the case where it is determined that the execution condition for the first mode is not satisfied, the control unit determines whether an execution condition (predetermined condition) for the second mode is satisfied. For example, the predetermined condition in the present disclosure may include at least one of a condition that the remaining amount of fuel of the internal combustion engine is equal to or larger than a second threshold and a condition that the parking position of the vehicle does not fall under a predetermined area (an area unsuitable for the execution of the second mode). The second threshold is a lower limit of a fuel remaining amount at which the execution of the remote air conditioning in the second mode is expected not to influence the traveling of the vehicle, and the like. As an example, the second threshold may be set to a larger value as the fuel consumption rate (g/PS·h or g/kW·h) of the internal combustion engine is higher. As an example, the predetermined area may be an area (idling prohibition area) where the idling of the internal combustion engine is prohibited. As anther example, the predetermined area may be an indoor area.

As an example, the determination of whether the parking position of the vehicle falls under the predetermined area may be performed by a method of collating map information in which the position of the predetermined area is registered and position information about the vehicle. As another example, the determination of whether the parking position of the vehicle falls under the predetermined area may be performed depending on a photographed image of a camera equipped in the vehicle and/or a detection signal of a sensor equipped in the vehicle.

In the case where it is determined that the predetermined condition is satisfied, the control unit controls the vehicle such that the second mode is executed. In this case, by actuating the internal combustion engine and generating electricity using the dynamic power of the internal combustion engine, it is possible to actuate the air conditioner using the electric power of the battery, while charging the battery.

Further, in the case where it is determined that the predetermined condition is not satisfied, the control unit performs neither the control for executing the first mode nor the control for executing the second mode. Thereby, it is possible to restrain the remote air conditioning from being executed in the case where there is a possibility that the travelable distance of the vehicle is excessively shortened or an influence is given to the environment around the vehicle.

With the information processing device according to the present disclosure, it is possible to more suitably perform the control of the air conditioner depending on the remote operation.

In the case where it is determined that neither the execution condition for the first mode nor the execution condition (predetermined condition) for the second mode is satisfied, the control unit may ask user's intention and then may control the vehicle such that the second mode is executed. As an example, a method for asking user's intention may be a method in which the control unit sends a command to display a screen for selecting whether the execution of the second mode is necessary, to the terminal that is used by the user of the vehicle. Then, in the case where an operation for a selection meaning that the execution of the second mode is necessary has been input to the terminal, a signal indicating that the selection meaning that the execution of the second mode is necessary has been performed may be sent from the terminal to the information processing device. In the information processing device that has received the signal, the control unit may control the vehicle such that the second mode is executed. Further, information indicating that neither the execution condition for the first mode nor the execution condition (predetermined condition) for the second mode is satisfied may be displayed on the screen for selecting whether the execution of the second mode is necessary. Thereby, it is possible to exceptionally execute the remote air conditioning, for example, in the case where there is a reason why the remote air conditioning is necessary.

In the case where the remote air conditioning is exceptionally executed as described above, the control unit may control the vehicle such that the second mode is executed in a state where a predetermined restriction is imposed. As an example, the predetermined restriction may include restricting the actuation time of the internal combustion engine to equal to or shorter than a predetermined time. Further, as another example, the predetermined restriction may include restricting the load on the internal combustion engine to equal to or lower than a predetermined load. Thereby, it is possible to execute the remote air conditioning, while minimizing the fuel consumption due to the execution of the second mode.

An embodiment of the present disclosure will be described below based on the drawings. The configuration of the following embodiment is an example, and the embodiment described below is just an example of the present disclosure in all respects. Various improvements and modifications may be performed without departing from the scope of the present disclosure. For carrying out the present disclosure, specific configurations depending on embodiments may be appropriately employed. Data mentioned in the embodiment is described in natural language, but more specifically, is designated in pseudo-language, commands, parameters, machine language, and others that can be recognized by computers.

### Embodiment

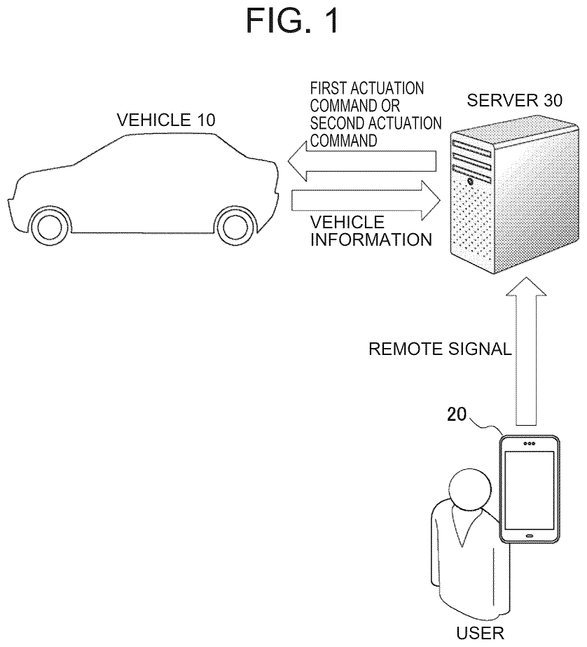

FIG. 1 is a diagram schematically showing an exemplary system to which the present disclosure is applied. The system according to the embodiment is configured to include a vehicle 10, a user terminal 20, and a server 30. In FIG. 1, only one vehicle 10 and only one user terminal 20 are illustrated, but a plurality of vehicles 10 and a plurality of user terminals 20 under the management of the server 30 can be included in the system.

The vehicle 10 is an HEV or PHEV that is equipped with a later-described air conditioner 120, a battery 130, an electric motor 140, an internal combustion engine 150, an electric generator 160, and the like. The vehicle 10 in the embodiment is configured to be capable of executing the remote air conditioning in the first mode and the remote air conditioning in the second mode. The remote air conditioning means that the air conditioner 120 of the vehicle 10 in a parked state (a state where a power switch or ignition switch has been turned off) is actuated by the remote operation. The first mode adopts a technique of actuating the air conditioner 120 using the electric power of the battery 130, without actuating the internal combustion engine 150. The second mode adopts a technique of actuating the air conditioner 120 using the electric power of the battery 130, while performing electric generation (the charge of the battery 130) with the electric generator 160 by actuating the internal combustion engine 150. The user terminal 20 is a computer that is used by the user of the vehicle 10. The server 30 is constituted by one or more computers that perform processes related to the remote operation of the vehicle 10.

In the system in the embodiment, the user inputs, to the user terminal 20, an operation for actuating the air conditioner before the user gets in the vehicle 10 in the parked state (the state where the power switch or ignition switch has been turned off). The user terminal 20 to which the operation has been input sends a remote signal to the server 30. The remote signal is a signal that includes an actuation request for the air conditioner, a target temperature of the interior (vehicle cabin) of the vehicle 10, and the like.

The server 30 that has received the remote signal acquires information (vehicle information) about the vehicle 10. As an example, the server 30 may cause the vehicle 10 to provide the vehicle information to the server 30, by sending a signal (occasionally referred to as a “request signal” hereinafter) for requesting the vehicle information, to the vehicle 10. As an example, the vehicle information may include an identifier (vehicle ID) of the vehicle 10, the remaining level (SOC) of the battery equipped in the vehicle 10, the fuel amount (remaining fuel amount) that is stored in a fuel tank equipped in the vehicle 10, the position information (information indicating the current position of the vehicle 10) about the vehicle 10, and the like.

The server 30 determines whether the execution condition (occasionally referred to as a “first condition” hereinafter) for the first mode is satisfied, depending on the acquired vehicle information. Details of the first condition will be described later. In the case where it is determined that the first condition is satisfied, the server 30 sends a command (first actuation command) to actuate the air conditioner 120 in the first mode, to the vehicle 10. The first actuation command is a signal that includes information designating the first mode, the target temperature of the vehicle cabin, and the like. In the vehicle 10 that has received the first actuation command, the air conditioner 120 is actuated in the first mode.

In the case where it is determined that the first condition is not satisfied, the server 30 determines whether the execution condition (occasionally referred to as a “second condition” hereinafter) for the second mode is satisfied. Details of the second condition will be described later. In the case where it is determined that the second condition is satisfied, the server 30 sends a command (second actuation command) to actuate the air conditioner 120 in the second mode, to the vehicle 10. The second actuation command is a signal that includes information designating the second mode, the target temperature of the vehicle cabin, and the like. In the vehicle 10 that has received the second actuation command, the air conditioner 120 is actuated in the second mode.

In the case where it is determined that the second condition is not satisfied, the server 30 sends neither the first actuation command nor the second actuation command, to the vehicle 10. In this case, in the vehicle 10, the air conditioner 120 is not actuated.

### Hardware Configuration of System

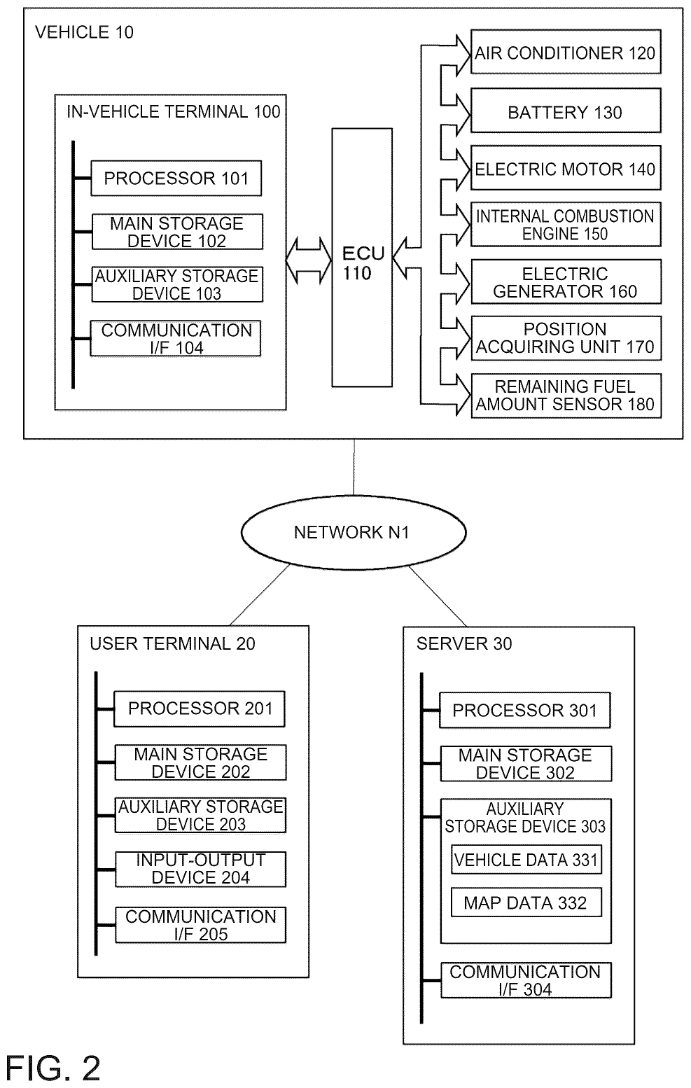

Respective hardware configurations of the vehicle 10, the user terminal 20 and the server 30 that are included in the system in the embodiment will be described based on FIG. 2. FIG. 2 is a diagram schematically showing respective exemplary hardware configurations of the vehicle 10, the user terminal 20 and the server 30 that are included in the system in the embodiment.

### Vehicle

First, the exemplary hardware configuration of the vehicle 10 will be described. As described above, the vehicle 10 in the embodiment is an HEV or PHEV. As shown in FIG. 2, the vehicle 10 in the embodiment is configured to include an in-vehicle terminal 100, an electronic control unit (ECU) 110, the air conditioner 120, the battery 130, the electric motor 140, the internal combustion engine 150, the electric generator 160, a position acquiring unit 170, and a remaining fuel amount sensor 180. The in-vehicle terminal 100, the ECU 110, the air conditioner 120, the battery 130, the electric motor 140, the internal combustion engine 150, the electric generator 160, the position acquiring unit 170, and the remaining fuel amount sensor 180 are connected to each other through an in-vehicle network based on a standard such as controller area network (CAN), local interconnect network (LIN), or FlexRay.

In FIG. 2, only hardware constituent elements related to the remote air conditioning are extracted and illustrated, and a hardware constituent element other than the hardware constituent elements shown in FIG. 2 can be equipped in the vehicle 10.

The in-vehicle terminal 100 is a computer that is equipped in the vehicle 10 and that communicates with the server 30 through the network N1. As shown in FIG. 2, the in-vehicle terminal 100 includes a processor 101, a main storage device 102, an auxiliary storage device 103, and a communication I/F 104. The processor 101, the main storage device 102, the auxiliary storage device 103, and the communication I/F 104 are connected to each other by a bus.

The processor 101 is an arithmetic processing unit such as a central processing unit (CPU), a graphics processing unit (GPU), or a digital signal processor (DSP). The processor 101 controls the in-vehicle terminal 100 by loading, on the main storage device 102, a program stored in the auxiliary storage device 103 and executing the program.

For example, the main storage device 102 is configured to include a semiconductor memory such as a random access memory (RAM) and a read only memory (ROM). The main storage device 102 provides a storage area and work area for loading the program stored in the auxiliary storage device 103. Further, the main storage device 102 is used as a buffer for the arithmetic processing by the processor 101.

For example, the auxiliary storage device 103 is an erasable programmable ROM (EPROM) or a hard disk drive (HDD). The auxiliary storage device 103 can include a removable medium, that is, a portable recording medium. For example, the removable media is a disc recording medium such as a universal serial bus (USB) memory, a compact disc (CD), or a digital versatile disc (DVD). The auxiliary storage device 103 stores various programs, and data and the like that are used by the processor 101 for the execution of the programs.

The programs stored in the auxiliary storage device 103 include dedicated programs for causing the processor 101 to execute processes related to the remote air conditioning, the vehicle ID of the vehicle 10, and the like, in addition to an operating system (OS). Some or all of the information stored in the auxiliary storage device 103 may be stored in the main storage device 102. Further, some of the information stored in the main storage device 102 may be stored in the auxiliary storage device 103. Furthermore, the vehicle ID may be held by the later-described ECU 110.

The communication I/F 104 is configured to includes a communication interface for connecting the in-vehicle terminal 100 to the in-vehicle network and a communication interface for connecting the in-vehicle terminal 100 to a network N1 in the vehicle exterior. In the embodiment, the communication I/F 104 communicates with the ECU 110 through the in-vehicle network. Further, in the embodiment, the communication I/F 104 communicates with the server 30 through the network N1 in the vehicle exterior. For example, the network N1 in the vehicle exterior is a wide area network (WAN) that is a global-scale public communication network, as exemplified by the internet, or other communication networks. The communication I/F 104 connects the in-vehicle terminal 100 to the network N1 using a mobile communication system (for example, 5th generation (5G), 6th generation (6G), or the like), or a wireless communication system such as Wi-Fi (R).

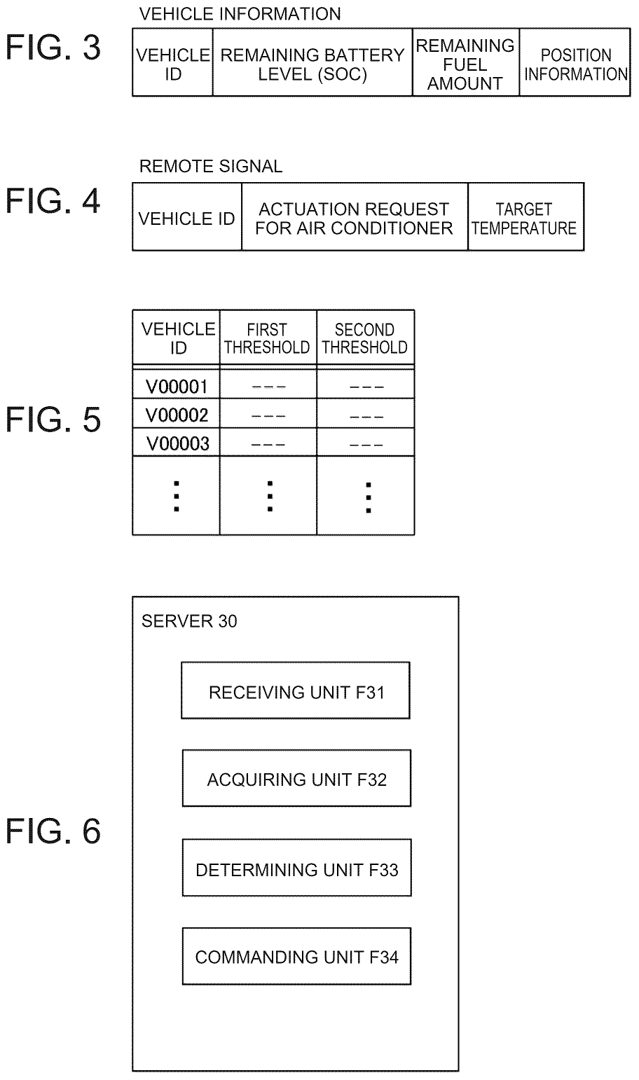

In the in-vehicle terminal 100 having the above configuration, when the communication I/F 104 receives the request signal sent from the server 30, the processor 101 generates the vehicle information. As an example, the processor 101 is connected to the in-vehicle network through the communication I/F 104, and communicates with the ECU 110 through the in-vehicle network. Thereby, the processor 101 acquires the remaining level (SOC) of the battery 130, the remaining fuel amount of the fuel tank, and the position information about the vehicle 10. Then, the processor 101 generates the vehicle information including the data acquired from the ECU 110. As an example, as shown in FIG. 3, the vehicle information may include the vehicle ID, the remaining level (SOC) of the battery 130, the remaining fuel amount of the fuel tank, the position information about the vehicle 10, and the like. The vehicle ID included in the vehicle information is the same as the vehicle ID stored in the auxiliary storage device 103. When the vehicle information is generated as described above, the processor 101 of the in-vehicle terminal 100 is connected to the network N1 in the vehicle exterior through the communication I/F 104, and sends the vehicle information to the server 30 through the network N1.

Further, in the in-vehicle terminal 100, when the communication I/F 104 receives the first actuation command or second actuation command sent from the server 30, the processor 101 sends the received first actuation command or second actuation command to the ECU 110 through the communication I/F 104 and the in-vehicle network.

Next, the air conditioner 120 is an electric air conditioner that performs air cooling or air heating of the vehicle cabin of the vehicle 10 using the electric power of the battery 130. The battery 130 supplies electric power to the electric motor 140 and the air conditioner 120. The electric motor 140 is operated using the electric power that is supplied from the battery 130. The internal combustion engine 150 is operated using the fuel that is stored in the fuel tank equipped in the vehicle 10. As an example, the electric motor 140 and the internal combustion engine 150 may drive the vehicle 10 in cooperation. As another example, the electric motor 140 may drive the vehicle 10, and the internal combustion engine 150 may drive the later-described electric generator 160 to charge the battery 130.

The electric generator 160 generates electricity, by converting the kinetic energy generated by the internal combustion engine 150, into electric energy. The electric generator 160 may perform so-called electricity regeneration in which the kinetic energy of drive wheels is converted into electric energy at the time of the deceleration traveling of the vehicle 10. The position acquiring unit 170 acquires the current position (geographical coordinates such as latitude and longitude) of the vehicle 10. As an example, the position acquiring unit 170 may be configured to include a global positioning system (GPS) receiver. As another example, the position acquiring unit 170 may be a wireless communication circuit that uses a position information service for Wi-Fi (R). The remaining fuel amount sensor 180 measures the amount (remaining fuel amount) of fuel that is stored in the fuel tank.

The ECU 110 is a computer that controls in-vehicle equipment such as the air conditioner 120, the electric motor 140, the internal combustion engine 150, and the electric generator 160. In the embodiment, the ECU 110 is configured to provide the SOC of the battery 130, the remaining fuel amount of the fuel tank, and the position information about the vehicle 10, to the in-vehicle terminal 100, in response to a request from the in-vehicle terminal 100. On that occasion, the ECU 110 may compute the SOC of the battery 130, using a known method such as an OCV method or a current integration method.

Further, the ECU 110 may acquire the remaining fuel amount of the fuel tank through the remaining fuel amount sensor 180. Furthermore, the ECU 110 may acquire the position information about the vehicle 10 through the position acquiring unit 170.

Further, the ECU 110 in the embodiment has also a function to control the air conditioner 120 in response to the first actuation command or second actuation command sent from the in-vehicle terminal 100 to the ECU 110. Specifically, in response to the reception of the first actuation command sent from the in-vehicle terminal 100, the ECU 110 actuates the air conditioner 120 at the target temperature included in the first actuation command. Thereby, in the vehicle 10, the remote air conditioning in the first mode is executed. Further, in response to the reception of the second actuation command sent from the in-vehicle terminal 100, the ECU 110 actuates the internal combustion engine 150 and the electric generator 160 to charge the battery 130, and actuates the air conditioner 120 at the target temperature included in the second actuation command. Thereby, in the vehicle 10, the remote air conditioning in the second mode is executed.

### User Terminal

Next, the exemplary hardware configuration of the user terminal 20 will be described. The user terminal 20 in the embodiment is a computer that is used by the user of the vehicle 10. For example, the user terminal 20 may be a smartphone, a tablet terminal, a wearable computer, a personal computer (PC), or the like. As shown in FIG. 2, the user terminal 20 in the embodiment is configured to include a processor 201, a main storage device 202, an auxiliary storage device 203, an input-output device 204, and a communication I/F 205. The processor 201, the main storage device 202, the auxiliary storage device 203, the input-output device 204, and the communication I/F 205 are connected to each other by a bus.

In FIG. 2, only hardware constituent elements related to the remote air conditioning are extracted and illustrated, and a hardware constituent element other than the hardware constituent elements shown in FIG. 2 can be included in the user terminal 20.

The processor 201, main storage device 202 and auxiliary storage device 203 of the user terminal 20 are the same as the processor 101, main storage device 102 and auxiliary storage device 103 of the in-vehicle terminal 100, respectively, and therefore, descriptions thereof are omitted. The auxiliary storage device 203 of the user terminal 20 stores a dedicated program (application program) for causing the processor 201 to execute functions related to the remote air conditioning.

The input-output device 204 accepts an input operation that is performed by the user, and presents information to the user. For example, the input-output device 204 is configured to include a touch panel display and a control circuit for the touch panel display. In the embodiment, the input-output device 204 outputs an operation screen (for example, a screen that includes an actuation request button for the air conditioner 120, a selection column for the target temperature of the vehicle cabin, and the like) for the remote air conditioning, and accepts an operation that is input on the operation screen. Information relevant to the operation accepted by the input-output device 204 is output from the input-output device 204 to the processor 201.

The communication I/F 205 is configured to include a communication interface for connecting the user terminal 20 to the network N1. The communication I/F 205 connects the user terminal 20 to the network N1, by a mobile communication system, a wireless communication system such as Wi-Fi (R), a LAN, or the like. In the embodiment, the communication I/F 205 communicates with the server 30 through the network N1.

In the user terminal 20 having the above configuration, when the operation (for example, the selection of the target temperature of the vehicle cabin and the tap of the actuation request button) for requesting the execution of the remote air conditioning is input to the input-output device 204 in a state where the input-output device 204 displays the operation screen for the remote air conditioning, the processor 201 sends the remote signal to the server 30 through the communication I/F 205. As an example, as shown in FIG. 4, the remote signal includes the vehicle ID of the vehicle 10, the actuation request for the air conditioner 120, and the target temperature of the vehicle cabin.

### Server

Next, the exemplary hardware configuration of the server 30 will be described. The server 30 in the embodiment is a computer that is operated by a provider of a remote air conditioning service. For example, the provider of the remote air conditioning service is a manufacturer of the vehicle 10, a business operator that receives commission from the manufacturer, or the like. As shown in FIG. 2, the server 30 is configured to include a processor 301, a main storage device 302, an auxiliary storage device 303, and a communication I/F 304.

In FIG. 2, only hardware constituent elements related to the remote air conditioning are extracted and illustrated, and a hardware constituent element other than the hardware constituent elements shown in FIG. 2 can be included in the server 30.

The processor 301, main storage device 302 and auxiliary storage device 303 of the server 30 are the same as the processor 101, main storage device 102 and the auxiliary storage device 103 of the in-vehicle terminal 100, respectively, and therefore, descriptions thereof are omitted. The auxiliary storage device 303 of the server 30 stores data such as vehicle data 331 and map data 332, in addition to an OS and a dedicated program for causing the processor 101 to execute processes related to the remote air conditioning.

The vehicle data 331 stored in the auxiliary storage device 303 will be described based on FIG. 5. FIG. 5 is a diagram schematically showing an example of the vehicle data 331. In the example shown in FIG. 5, the vehicle data 331 includes a plurality of records each of which corresponds to one vehicle. Each of the plurality of records included in the vehicle data 331 includes a vehicle ID field, a first threshold field, and a second threshold field.

In the vehicle ID field, information for identifying each of a plurality of vehicles 10 under the management of the server 30 is registered. The information registered in the vehicle ID field may be the same as the vehicle ID that is held by the in-vehicle terminal 100 (auxiliary storage device 103) of the vehicle 10.

In the first threshold field, respective first thresholds corresponding to the plurality of vehicles 10 under the management of the server 30 are registered. The first threshold is a lower limit of a remaining battery level (SOC) at which the execution of the remote air conditioning in the first mode is expected not to influence the traveling of the vehicle, and the like. As an example, the first threshold may be decided depending on the capacity of each battery 130 equipped in the plurality of vehicles 10 under the management of the server 30. In that case, the first threshold may be set to a larger value as the capacity of the battery 130 is lower.

In the second threshold field, respective second thresholds corresponding to the plurality of vehicles 10 under the management of the server 30 are registered. The second threshold is a lower limit of a remaining fuel amount at which the execution of the remote air conditioning in the second mode is expected not to influence the traveling of the vehicle, and the like. As an example, the second threshold may be decided depending on the fuel consumption rate (g/PS·h or g/kW·h) of each internal combustion engine equipped in the plurality of vehicles 10 under the management of the server 30. In that case, the second threshold may be set to a larger value as the fuel consumption rate (g/PS·h or g/kW·h) of the internal combustion engine 150 is higher.

Back to the description of FIG. 2, the map data 332 stored in the auxiliary storage device 303 of the server 30 will be described. The map data 332 includes map data, information for identifying whether each spot on the map data falls under the predetermined area. The predetermined area includes the idling prohibition area (for example, a parking space of a shop in a residential section, a parking space in an environmental protection zone, and the like), and the indoor area (for example, a parking space surrounded by a roof and walls, and the like). The map data 332 may be provided from an external device that is connected to the server 30 through the network N1.

The communication I/F 304 of the server 30 is a communication interface for connecting the server 30 to the network N1. As an example, the communication I/F 304 may be configured to include a network interface board, a wireless communication interface for wireless communication, and the like. In the embodiment, the communication I/F 304 communicates with the user terminal 20 and the in-vehicle terminal 100 through the network N1.

In the hardware configuration of the server 30, exclusion, replacement and addition of constituent elements can be appropriately performed depending on embodiments. For example, the server 30 may include a plurality of processors. Further, the server 30 may be configured to include a plurality of computers. Furthermore, the server 30 may be configured to include an external storage device that is connected through the network N1.

### Software Configuration of Server

Next, the software configuration of the server 30 will be described based on FIG. 6. FIG. 6 is a block diagram schematically showing an exemplary software configuration of the server 30. The processor 301 executes programs stored in the auxiliary storage device 303, and thereby, the server 30 behaves as a computer that includes a receiving unit F31, an acquiring unit F32, a determining unit F33, and a commanding unit F34 as software modules.

At least a part of the receiving unit F31, the acquiring unit F32, the determining unit F33, and the commanding unit F34 may be realized by a hardware circuit such as an application specific integrated circuit (ASIC) or a field programmable gate array (FPGA).

The receiving unit F31 receives the remote signal sent from the user terminal 20 to the server 30, through the communication I/F 304. When the receiving unit F31 receives the remote signal, the processor 301 of the server 30 behaves as the acquiring unit F32.

The acquiring unit F32 acquires the vehicle information from the vehicle 10 (occasionally referred to as an “object vehicle 10” hereinafter) that is the object of the remote signal. Specifically, first, the acquiring unit F32 specifies the in-vehicle terminal 100 of the object vehicle 10, based on the vehicle ID included in the remote signal (see FIG. 4). Subsequently, the acquiring unit F32 sends the request signal to the specified in-vehicle terminal 100 through the communication I/F 304. As described above, the request signal is a signal for requesting the vehicle information about the object vehicle 10.

When the vehicle information is sent from the in-vehicle terminal 100 of the object vehicle 10 to the server 30 in response to the request signal, the acquiring unit F32 acquires the vehicle information through the communication I/F 304. When the acquiring unit F32 acquires the vehicle information, the processor 301 of the server 30 behaves as the determining unit F33.

The determining unit F33 determines whether an execution condition for the remote air conditioning is satisfied, depending on the vehicle information about the object vehicle 10. Specifically, first, the determining unit F33 determines whether the execution condition (first condition) for the first mode is satisfied. The first condition in the embodiment includes a condition that the remaining battery level (SOC) of the object vehicle 10 is equal to or higher than the first threshold. The determination of whether the first condition is satisfied is performed using the remaining battery level (SOC) included in the vehicle information (see FIG. 3) and the vehicle data 331 stored in the auxiliary storage device 303. Specifically, the determining unit F33 accesses the vehicle data 331 using the vehicle ID included in the vehicle information as an argument, and specifies a record in which information that coincides with the vehicle ID included in the vehicle information is registered in the vehicle ID field. The determining unit F33 compares the first threshold registered in the first threshold field of the specified record and the remaining battery level (SOC) included in the vehicle information. In the case where the remaining battery level (SOC) is equal to or higher than the first threshold, the determining unit F33 determines that the first condition is satisfied. On the other hand, in the case where the remaining battery level (SOC) is lower than the first threshold, the determining unit F33 determines that the first condition is not satisfied.

In the case where it is determined that the first condition is not satisfied, the determining unit F33 determines whether the execution condition (second condition) for the second mode is satisfied. The second condition in the embodiment includes a condition that the remaining fuel amount of the object vehicle 10 is equal to or larger than the second threshold and a condition that the current position of the object vehicle 10 is outside the predetermined area (corresponding to the “predetermined condition” in the present disclosure). The determination of whether the second condition is satisfied is performed using the remaining fuel amount included in the vehicle information, the position information included in the vehicle information, the vehicle data 331 stored in the auxiliary storage device 303, and the map data 332 stored in the auxiliary storage device 303. Specifically, the determining unit F33 accesses the vehicle data 331 using the vehicle ID included in the vehicle information as an argument, and specifies a record in which information that coincides with the vehicle ID included in the vehicle information is registered in the vehicle ID field. The determining unit F33 compares the second threshold registered in the second threshold field of the specified record and the remaining fuel amount included in the vehicle information. Further, the determining unit F33 collates the position information included in the vehicle information and the map data 332 stored in the auxiliary storage device 303. In the case where the remaining fuel amount is equal to or larger than the second threshold and where the current position of the object vehicle 10 is outside the predetermined area, the determining unit F33 determines that the second condition is satisfied. Further, in the case where the remaining fuel amount is smaller than the second threshold and/or where the current position of the object vehicle 10 is inside the predetermined area, the determining unit F33 determines that the second condition is not satisfied.

In the case where the object vehicle 10 is equipped with a camera, a sensor and the like that detect physical bodies (for example, a signboard indicating idling prohibition, a roof, a wall, and the like) around the object vehicle 10, the determining unit F33 may determine whether the current position of the object vehicle 10 is outside the predetermined area, depending on detection results of the camera, the sensor and the like. In the case where this method is employed, the vehicle information including the detection results of the camera, the sensor and the like of the object vehicle 10 may be provided from the in-vehicle terminal 100 to the server 30.

When the determination process by the determining unit F33 ends, the processor 301 of the server 30 behaves as the commanding unit F34.

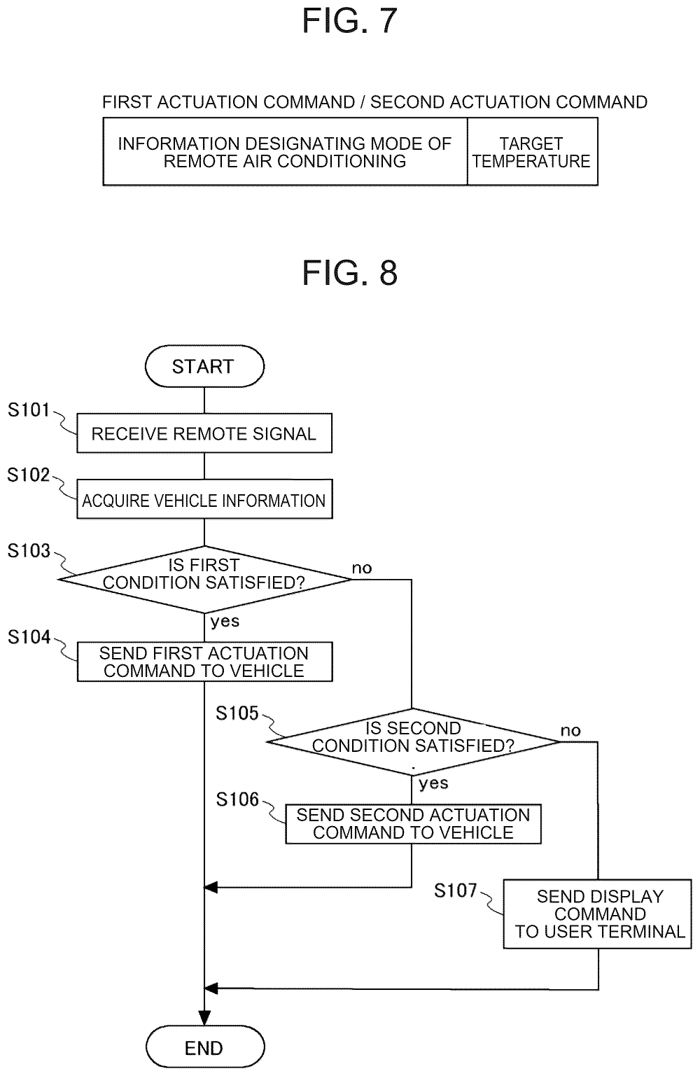

The commanding unit F34 sends a command depending on the determination result of the determining unit F33, to one of the in-vehicle terminal 100 of the object vehicle 10 and the user terminal 20. In the case where the determining unit F33 determines that the first condition is satisfied, the commanding unit F34 sends the first actuation command to the in-vehicle terminal 100 of the object vehicle 10 through the communication I/F 304. As shown in FIG. 7, the first actuation command includes the information designating the mode of the remote air conditioning (in this case, the information designating the first mode), the target temperature of the vehicle cabin, and the like. The target temperature of the vehicle cabin may be the same as the target temperature included in the remote signal received from the user terminal 20.

When the first actuation command sent from the commanding unit F34 is received by the in-vehicle terminal 100 of the object vehicle 10, the first actuation command is sent from the in-vehicle terminal 100 to the ECU 110 through the in-vehicle network. The ECU 110 that has received the first actuation command actuates the air conditioner 120 in the first mode. That is, the ECU 110 actuates the air conditioner 120 using the electric power of the battery 130, without actuating the internal combustion engine 150 and the electric generator 160. On that occasion, the ECU 110 controls the air conditioner 120 such that the temperature of the vehicle cabin becomes the target temperature included in the first actuation command.

Further, in the case where the determining unit F33 determines that the first condition is not satisfied and the second condition is satisfied, the commanding unit F34 sends the second actuation command to the in-vehicle terminal 100 of the object vehicle 10 through the communication I/F 304. Similarly to the first actuation command, the second actuation command includes the information designating the mode of the remote air conditioning (in this case, the information designating the second mode), the target temperature of the vehicle cabin, and the like (see FIG. 7).

When the second actuation command sent from the commanding unit F34 is received by the in-vehicle terminal 100 of the object vehicle 10, the second actuation command is sent from the in-vehicle terminal 100 to the ECU 110 through the in-vehicle network. The ECU 110 that has received the second actuation command actuates the air conditioner 120 in the second mode. That is, the ECU 110 charges the battery 130 by actuating the internal combustion engine 150 and the electric generator 160, and actuates the air conditioner 120 using the electric power of the battery 130. On that occasion, the ECU 110 controls the air conditioner 120 such that the temperature of the vehicle cabin becomes the target temperature included in the second actuation command.

Further, in the case where the determining unit F33 determines that neither the first condition nor the second condition is satisfied, the commanding unit F34 sends a display command to the user terminal 20 through the communication I/F 304. The display command in the embodiment is a command to display information indicating that the remote air conditioning has not been executed. The display command may include a command to display information relevant to the reason why the remote air conditioning has not been executed (for example, information indicating that the remaining battery level (SOC) is lower than the first threshold, the remaining fuel amount is smaller than the second threshold, or the vehicle 10 is inside the predetermined area).

When the display command sent from the commanding unit F34 is received by the user terminal 20, the processor 201 of the user terminal 20 causes the input-output device 204 to display the information indicating that the remote air conditioning has not been executed, and the information relevant to the reason why the remote air conditioning has not been executed. Thereby, the user of the object vehicle 10 can know the inexecution of the remote air conditioning and the reason for the inexecution of the remote air conditioning.

In the case where the remote air conditioning in the first mode or second mode has been executed, the commanding unit F34 may send a command to display information indicating that the remote air conditioning in the first mode or the second mode has been executed, to the user terminal 20. In that case, the user of the object vehicle 10 can know whether the remote air conditioning has been executed in the first mode or in the second mode.

The software configuration of the server 30 is not limited to the example shown in FIG. 6, and exclusion, replacement and addition of software constituent elements can be appropriately performed depending on embodiments.

### Flow of Process

Next, a flow of the process that is executed by the server 30 in the embodiment will be described based on FIG. 8. FIG. 8 is a flowchart showing an exemplary processing routine that is executed by the server 30 at the time when the remote signal sent from the user terminal 20 is received. The execution subject of the processing routine in FIG. 8 is the processor 301 of the server 30. However, descriptions will be made while the software modules of the server 30 are regarded as the execution subject.

When the remote signal sent from the user terminal 20 is received by the communication I/F 304 of the server 30, the processor 301 of the server 30 behaves as the receiving unit F31, by executing a program in the auxiliary storage device 303. The receiving unit F31 receives the remote signal sent from the user, through the communication I/F 304 (step S101). When the receiving unit F31 completes the execution of the process in step S101, the processor 301 of the server 30 behaves as the acquiring unit F32, and executes a process in step S102.

In step S102, the acquiring unit F32 acquires the vehicle information about the vehicle 10 (object vehicle 10) that is the object of the remote signal. Specifically, first, the acquiring unit F32 specifies the in-vehicle terminal 100 of the object vehicle 10, based on the vehicle ID included in the remote signal (see FIG. 4). Subsequently, the acquiring unit F32 sends the request signal to the specified in-vehicle terminal 100 through the communication I/F 304. Then, when the vehicle information is sent from the in-vehicle terminal 100 of the object vehicle 10 to the server 30 in response to the request signal, the acquiring unit F32 acquires the vehicle information through the communication I/F 304. When the acquiring unit F32 completes the process in step S102, the processor 301 of the server 30 behaves as the determining unit F33, and executes a process in step S103.

In step S103, the determining unit F33 determines whether the first condition is satisfied, depending on the vehicle information acquired from the object vehicle 10. Specifically, first, the determining unit F33 accesses the vehicle data 331 using the vehicle ID included in the vehicle information as an argument, and specifies the record in which the information that coincides with the vehicle ID included in the vehicle information is registered in the vehicle ID field. The determining unit F33 compares the first threshold registered in the first threshold field of the specified record and the remaining battery level (SOC) included in the vehicle information. In the case where the remaining battery level (SOC) is equal to or higher than the first threshold, the determining unit F33 determines that the first condition is satisfied (the positive determination in step S103). On the other hand, in the case where the remaining battery level (SOC) is lower than the first threshold, the determining unit F33 determines that the first condition is not satisfied (the negative determination in step S103).

In the case where the positive determination is made in step S103 (in the case where it is determined that the first condition is satisfied), the processor 301 of the server 30 behaves as the commanding unit F34, and executes a process in step S104. In step S104, the commanding unit F34 sends the first actuation command to the in-vehicle terminal 100 of the target vehicle 10 through the communication I/F 304. As described above, the first actuation command includes the information designating the first mode and the target temperature of the vehicle cabin.

When the first actuation command sent from the commanding unit F34 is received by the in-vehicle terminal 100 of the object vehicle 10, the first actuation command is sent from the in-vehicle terminal 100 to the ECU 110 through the in-vehicle network. The ECU 110 that has received the first actuation command actuates the air conditioner 120 in the first mode.

When the commanding unit F34 completes the process in step S104, the processor 301 of the server 30 ends the execution of the processing routine shown in FIG. 8.

Further, in the case where the negative determination is made in step S103 (in the case where it is determined that the first condition is not satisfied), the processor 301 of the server 30 behaves as the determining unit F33, and executes a process in step S105. In step S105, the determining unit F33 determines whether the second condition is satisfied, depending on the vehicle information about the object vehicle 10. Specifically, the determining unit F33 compares the second threshold registered in the second threshold field of the record (the record that is of the plurality of records included in the vehicle data 331 and in which the information that coincides with the vehicle ID included in the vehicle information is registered in the vehicle ID field) specified in step S103 and the remaining fuel amount included in the vehicle information. Further, the determining unit F33 collates the position information included in the vehicle information and the map data 332 stored in the auxiliary storage device 303. Then, in the case where the remaining fuel amount is equal to or larger than the second threshold and where the current position of the object vehicle 10 is outside the predetermined area, the determining unit F33 determines that the second condition is satisfied (the positive determination in step S105). On the other hand, in the case where the remaining fuel amount is smaller than the second threshold and/or where the current position of the object vehicle 10 is inside the predetermined area, the determining unit F33 determines that the second condition is not satisfied (the negative determination in step S105).

In the case where the positive determination is made in step S105 (in the case where it is determined that the second condition is satisfied), the processor 301 of the server 30 behaves as the commanding unit F34, and executes a process in step S106. In step S106, the commanding unit F34 sends the second actuation command to the in-vehicle terminal 100 of the object vehicle 10 through the communication I/F 304. As described above, the second actuation command includes the information designating the second mode and the target temperature of the vehicle cabin.

When the second actuation command sent from the commanding unit F34 is received by the in-vehicle terminal 100 of the object vehicle 10, the second actuation command is sent from the in-vehicle terminal 100 to the ECU 110 through the in-vehicle network. The ECU 110 that has received the second actuation command actuates the air conditioner 120 in the second mode.

When the commanding unit F34 completes the execution of the process in step S106, the processor 301 of the server 30 ends the execution of the processing routine shown in FIG. 8.

Further, in the case where the negative determination is made in step S105 (in the case where it is determined that the second condition is not satisfied), the processor 301 of the server 30 behaves as the commanding unit F34, and executes a process in step S107. In step S107, the commanding unit F34 sends the display command to the user terminal 20 that is used by the user of the object vehicle 10, through the communication I/F 304. The display command includes the command to display the information indicating that the remote air conditioning has not been executed and the information relevant to the reason why the remote air conditioning has not been executed.

When the display command sent from the server 30 is received by the user terminal 20, the processor 201 of the user terminal 20 causes the input-output device 204 to display the information indicating that the remote air conditioning has not been executed and the information relevant to the reason why the remote air conditioning has not been executed.

When the commanding unit F34 completes the execution of the process in step S107, the processor 301 of the server 30 ends the execution of the processing routine shown in FIG. 8.

### Function Effect of Embodiment

In the above-described embodiment, in the case where the first condition (the remaining battery level is equal to or higher than the first threshold) is not satisfied and where the second condition (the remaining fuel amount is equal to or larger than the second threshold and the current position of the object vehicle 10 is outside the predetermined area) is satisfied, the remote air conditioning is executed in the second mode. Further, in the case where the first condition is not satisfied and where the second condition is not satisfied, the remote air conditioning in the second mode is not executed.

Consequently, in the embodiment, in the case where the first condition is not satisfied, the remote air conditioning in the second mode can be executed, on the condition that the remaining fuel amount is equal to or larger than the second threshold and the current position of the object vehicle 10 is outside the predetermined area. Thereby, it is possible to restrain the remote air conditioning in the second mode from being executed in the case where there is a possibility that the travelable distance of the object vehicle 10 is excessively shortened or an influence is given to the environment around the object vehicle 10. Consequently, it is possible to more suitably perform the control of the air conditioner 120 depending on the remote operation.

### Modification

In the example described in the above embodiment, in the case where neither the first condition nor the second condition is satisfied, neither the remote air conditioning in the first mode nor the remote air conditioning in the second mode is executed. However, in the case where neither the first condition nor the second condition is satisfied, the user may select whether the execution of the remote air conditioning in the second mode is necessary.

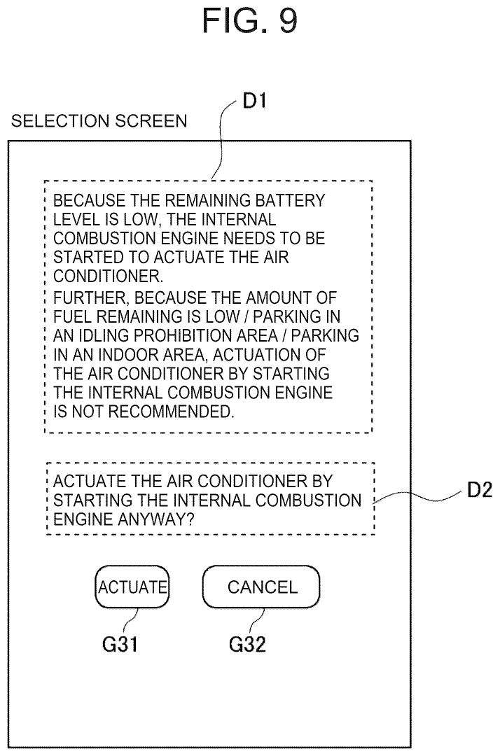

In a modification, in the case where the determining unit F33 of the server determines that neither the first condition nor the second condition is satisfied, the commanding unit F34 sends a selection command to the user terminal 20, instead of the display command. The selection command is a command to cause the user to select whether the execution of the remote air conditioning in the second mode is necessary. As an example, the selection command may be a command to cause the input-output device 204 of the user terminal 20 to display a selection screen shown in FIG. 9. In the example shown in FIG. 9, the selection screen includes a display column (D1 in FIG. 9) for character information that describes that neither the first condition nor the second condition is satisfied, a display column (D2 in FIG. 9) for character information that prompts the user to select whether the execution of the remote air conditioning in the second mode is necessary, and GUI components (an actuation button G31 and a cancel button G32 in FIG. 9) for selecting whether the execution of the remote air conditioning in the second mode is necessary.

In the case where the user taps the actuation button G31 in a state where the selection screen shown in FIG. 9 is displayed by the input-output device 204 of the user terminal 20, the processor 201 of the user terminal 20 sends an actuation request signal to the server 30 through the communication I/F 205. The actuation request signal is a signal indicating that the user has performed a selection meaning that the execution of the remote air conditioning is necessary. Further, in the case where the user taps the cancel button G32 in the state where the selection screen shown in FIG. 9 is displayed by the input-output device 204 of the user terminal 20, the processor 201 of the user terminal 20 sends a cancel request signal to the server 30 through the communication I/F 205. The cancel request signal is a signal indicating that the user has performed a selection meaning that the execution of the remote air conditioning is not necessary.

In the case where the actuation request signal sent from the user terminal 20 is received by the communication I/F 304 of the server 30, the commanding unit F34 of the server 30 sends the second actuation command to the in-vehicle terminal 100 of the object vehicle 10. Thereby, even in the case where neither the first condition nor the second condition is satisfied, it is possible to exceptionally execute the remote air conditioning in the second mode after asking user's intention. Further, in the case where the cancel request signal sent from the user terminal 20 is received by the communication I/F 304 of the server 30, the commanding unit F34 of the server 30 does not send the second actuation command to the in-vehicle terminal 100 of the object vehicle 10. Thereby, in the case where neither the first condition nor the second condition is satisfied, it is possible to cancel the execution of the remote air conditioning after asking user's intention.

In the case where the remote air conditioning in the second mode is exceptionally executed as described above, the remote air conditioning may be executed in a state where a predetermined restriction is imposed. As an example, the predetermined restriction may be restricting the actuation time (the execution time of the remote air conditioning in the second mode) of the internal combustion engine 150 to equal to or shorter than a predetermined time. In that case, the second actuation command that is sent from the server 30 to the in-vehicle terminal 100 includes a command to restrict the execution time of the remote air conditioning in the second mode to equal to or shorter than the predetermined time. Further, as another example, the predetermined restriction may be restricting the load on the internal combustion engine 150 to equal to or lower than a predetermined load. In that case, the second actuation command that is sent from the server 30 to the in-vehicle terminal 100 may include a command to restrict the load on the internal combustion engine 150 during the execution of the remote air conditioning in the second mode to equal to or lower than the predetermined load.

### Flow of Process

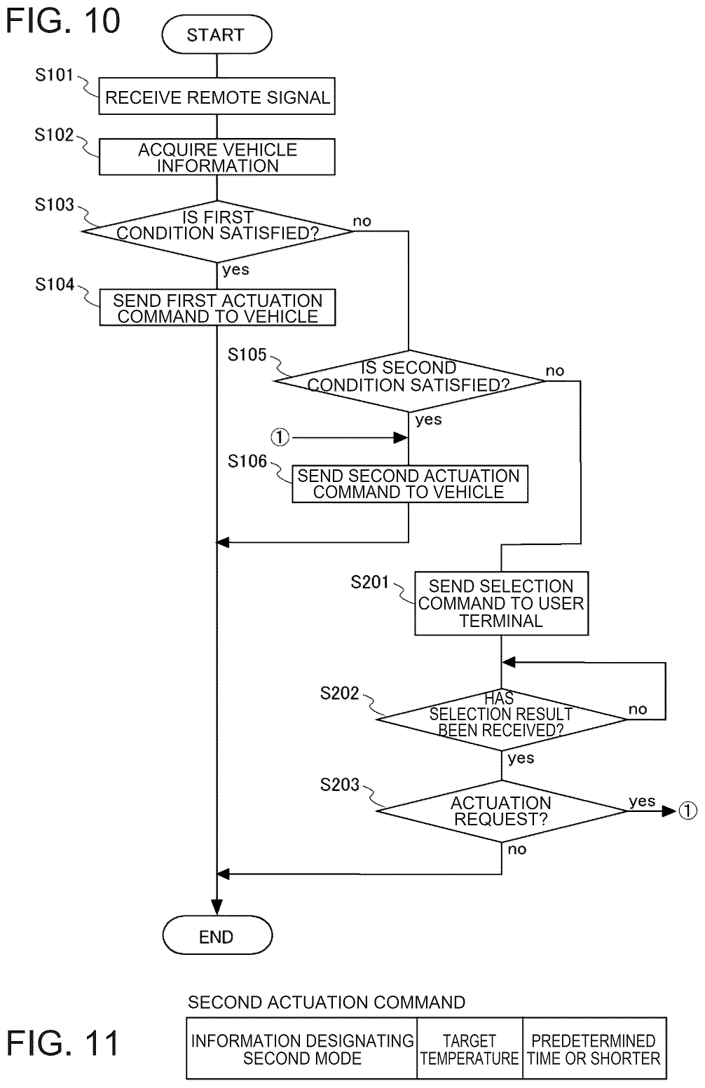

A flow of the process that is executed by the server 30 in the modification will be described based on FIG. 10. FIG. 10 is a flowchart showing an exemplary processing routine that is executed by the server 30 at the time when the remote signal sent from the user terminal 20 is received. In FIG. 10, the same processes as those in FIG. 8 are denoted by the same reference characters as those in FIG. 8, and descriptions thereof are omitted.

In FIG. 10, in the case where the negative determination is made in step S105, the commanding unit F34 of the server 30 executes processes in steps S201 to S203, instead of step S107 in FIG. 8.

In step S201, the commanding unit F34 sends the selection command to the user terminal 20 that is used by the user of the object vehicle 10, through the communication I/F 304. As described above, the selection command is the command to cause the user to select whether the remote air conditioning in the second mode is exceptionally executed (the command to display the above-described selection screen exemplified in FIG. 9).

When the selection command sent from the server 30 is received by the user terminal 20, the processor 201 of the user terminal 20 causes the input-output device 204 to display the above-described selection screen exemplified in FIG. 9. When the user taps the actuation button G31 or the cancel button G32 in the state where the selection screen shown in FIG. 9 is displayed by the input-output device 204 of the user terminal 20, the processor 201 of the user terminal 20 sends the signal (actuation request signal or cancel request signal) indicating the selection result of the user, to the server 30 through the communication I/F 205.

In step S202, the commanding unit F34 determines whether the communication I/F 304 has received the signal indicating the selection result of the user. In the case where the communication I/F 304 has not received the signal indicating the selection result of the user (the negative determination in step S202), the commanding unit F34 waits until the communication I/F 304 receives the signal. In the case where the communication I/F 304 has received the signal indicating the selection result of the user (the positive determination in step S202), the commanding unit F34 executes a process in step S203.

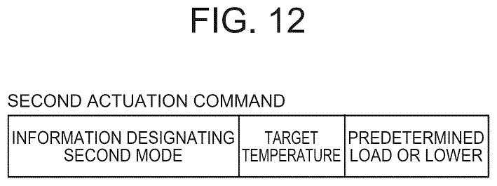

In step S203, the commanding unit F34 determines whether the signal indicating the selection result of the user is the actuation request signal. In the case where the signal indicating the selection result of the user is not the actuation request signal but the cancel request signal (the negative determination in step S203), the commanding unit F34 ends the execution of the processing routine in FIG. 10. On the other hand, in the case where the signal indicating the selection result of the user is the actuation request signal (the positive determination in step S203), the commanding unit F34 executes the process in step S106. That is, the commanding unit F34 sends the second actuation command to the in-vehicle terminal 100 of the target vehicle 10 through the communication I/F 304. The second actuation command in that case may include a command relevant to the predetermined restriction. As an example, as shown in FIG. 11, the second actuation command may include the information designating the second mode, the target temperature of the vehicle cabin, information for restricting the execution time of the remote air conditioning in the second mode to equal to or shorter than the predetermined time, and the like. As another example, as shown in FIG. 12, the second actuation command may include the information designating the second mode, the target temperature of the vehicle cabin, information for restricting the load on the internal combustion engine 150 during the execution of the remote air conditioning in the second mode to equal to or lower than the predetermined load, and the like.

### Function Effect of Modification

In the modification, in the case where the first condition (the remaining battery level is equal to or higher than the first threshold) is not satisfied and where the second condition (the remaining fuel amount is equal to or larger than the second threshold and the current position of the object vehicle 10 is outside the predetermined area) is not satisfied, the command (selection command) to cause the user to select whether the execution of the remote air conditioning in the second mode is necessary is sent from the server 30 to the user terminal 20. Then, in the case where the user has performed the selection meaning that the execution of the remote air conditioning in the second mode is necessary, the remote air conditioning in the second mode is exceptionally executed.

Consequently, in the modification, even in the case where neither the first condition nor the second condition is satisfied, it is possible to exceptionally execute the remote air conditioning in the second mode after asking user's intention. Thereby, for example, in the case where there is a reason why the remote air conditioning is necessary, it is possible to exceptionally execute the remote air conditioning, even when neither the first condition nor the second condition is satisfied. Furthermore, when the remote air conditioning in the second mode is executed in the state where the predetermined restriction is imposed, it is possible to execute the remote air conditioning, while minimizing the fuel consumption of the internal combustion engine 150 due to the execution of the remote air conditioning in the second mode. As a result, it is possible to enhance the convenience for the user that uses the remote air conditioning service.

### Others

The above embodiment and the above modification are just examples, and the present disclosure can be carried out while being appropriately altered without departing from the spirit of the present disclosure. For example, the above embodiment and the above modification can be carried out while being combined if possible.

The processes and means described in the present disclosure can be carried out while being freely combined as long as there is no technical inconsistency. Furthermore, a process described as a process that is performed by a single device may be collaboratively executed by a plurality of devices. Further, a process described as a process that is performed by different devices may be executed by a single device. For example, at least some of the processes by the acquiring unit F32 of the server 30, the processes by the determining unit F33, and the processes by the commanding unit F34 may be executed by the in-vehicle terminal 100.

Further, the present disclosure can be realized also by supplying a computer program implementing the functions described in the above embodiment to the server 30 and reading and executing the computer program by one or more processors included in the server 30. The computer program may be provided to the computer by a non-transitory computer-readable storage medium that can be connected to a system bus of the computer, or may be provided to the computer through a network. The non-transitory computer readable storage medium is a recording medium that can accumulate information such as data and programs by electric, magnetic, optical, mechanical or chemical action and that can read the information from the computer or the like. For example, the recording medium may be an arbitrary type of disk such as a magnetic disk (a floppy (R) disk, a hard disk drive (HDD), or the like) or an optical disk (a CD-ROM, a DVD disk, a Blu-ray disk, or the like). The recording medium may be a medium such as a read-only memory (ROM), a random access memory (RAM), an EPROM, an EEPROM, a magnetic card, a flash memory, an optical card, or a solid state drive (SSD).

What is claimed is:

1. An information processing device that controls a vehicle that executes a first mode and a second mode, the first mode being a mode in which an air conditioner is actuated by electric power of a battery, the second mode being a mode in which the air conditioner is actuated by electric power that is generated using dynamic power of an internal combustion engine, the information processing device comprising a processor, wherein
the processor is configured to:
receive an actuation request for the air conditioner by a remote operation,
determine whether a remaining amount of the battery is equal to or higher than a first threshold, in response to receiving the actuation request,
determine whether a predetermined condition that is an execution condition for the second mode is satisfied, in response to determination is made that the remaining amount of the battery is less than the first threshold, and
control the vehicle such that the second mode is executed, in response to determination is made that the predetermined condition is satisfied.

2. The information processing device according to claim 1, wherein the processor is configured to send a command to a terminal, in case where determination is made that the predetermined condition is not satisfied is made, the command being a command to display a screen for selecting whether execution of the second mode is necessary, the terminal being a terminal that is used by a user of the vehicle.

3. The information processing device according to claim 2, wherein the processor is configured to control the vehicle such that the second mode is executed, in case where a signal is received from the terminal, the signal indicating that the execution of the second mode is selected as necessary.

4. The information processing device according to claim 2, wherein the processor is configured to control the vehicle such that the second mode is executed in a state where a predetermined restriction is imposed, in case where a signal is received from the terminal, the signal indicating that the execution of the second mode is selected as necessary.

5. The information processing device according to claim 4, wherein the predetermined restriction includes restricting an actuation time of the internal combustion engine to equal to or shorter than a predetermined time.

6. The information processing device according to claim 4, wherein the predetermined restriction includes restricting a load on the internal combustion engine to equal to or lower than a predetermined load.

7. The information processing device according to claim 1, wherein the predetermined condition includes a condition that a remaining amount of fuel of the internal combustion engine is equal to or larger than a second threshold.

8. The information processing device according to claim 1, wherein the predetermined condition includes a condition that a parking position of the vehicle does not fall under a predetermined area, the predetermined area being an area unsuitable for execution of the second mode.

9. The information processing device according to claim 8, wherein the predetermined area includes at least one of an idling prohibition area and an indoor area.

10. An information processing method for controlling a vehicle that executes a first mode and a second mode, the first mode being a mode in which an air conditioner is actuated by electric power of a battery, the second mode being a mode in which the air conditioner is actuated by electric power that is generated using dynamic power of an internal combustion engine, the information processing method comprising:
receiving an actuation request for the air conditioner by a remote operation;
determining whether a remaining amount of the battery is equal to or higher than a first threshold, in response to receiving the actuation request;
determining whether a predetermined condition that is an execution condition for the second mode is satisfied, in response to determination is made that the remaining amount of the battery is less than the first threshold; and
controlling the vehicle such that the second mode is executed, in response to determination is made that the predetermined condition is satisfied.

11. The information processing method according to claim 10, further comprising sending a command to a terminal, in case where determination is made that the predetermined condition is not satisfied is made, the command being a command to display a screen for selecting whether execution of the second mode is necessary, the terminal being a terminal that is used by a user of the vehicle.

12. The information processing method according to claim 11, further comprising controlling the vehicle such that the second mode is executed, in case where a signal is received from the terminal, the signal indicating that the execution of the second mode is selected as necessary.

13. The information processing method according to claim 11, further comprising controlling the vehicle such that the second mode is executed in a state where a predetermined restriction is imposed, in case where a signal is received from the terminal, the signal indicating that the execution of the second mode is selected as necessary.

14. The information processing method according to claim 13, wherein the predetermined restriction includes restricting an actuation time of the internal combustion engine to equal to or shorter than a predetermined time.

15. The information processing method according to claim 13, wherein the predetermined restriction includes restricting a load on the internal combustion engine to equal to or lower than a predetermined load.

16. The information processing method according to claim 10, wherein the predetermined condition includes a condition that a remaining amount of fuel of the internal combustion engine is equal to or larger than a second threshold.

17. The information processing method according to claim 10, wherein the predetermined condition includes a condition that a parking position of the vehicle does not fall under a predetermined area, the predetermined area being an area unsuitable for execution of the second mode.

18. The information processing method according to claim 17, wherein the predetermined area includes at least one of an idling prohibition area and an indoor area.
